(19) United States
(12) Patent Application Publication
(10) Pub. No.: US 2025/0314210 A1
(43) Pub. Date: Oct. 9, 2025

(54) CALIBRATION SYSTEM AND METHOD FOR FUEL INJECTION CALIBRATION

(71) Applicant: Cummins Power Generation, Inc, Minneapolis, MN (US)

(72) Inventors: Andrew Guy Kitchen, Daventry (GB); Axel O. zur Loye, Columbus, IN (US)

(73) Assignee: Cummins Power Generation, Inc, Minneapolis, MN (US)

(21) Appl. No.: 18/629,706

(22) Filed: Apr. 8, 2024

(51) Int. Cl. F02D 19/06; F02D 41/40

(52) U.S. Cl. CPC F02D 19/061; F02D 19/0692; F02D 41/402

(57) ABSTRACT

The present disclosure relates to a system and method for fuel injection calibration for use with a fuel injector coupled with an engine. The method includes operating the fuel injector according to a parameter for the fuel injector that corresponds to a first target load for the engine, detecting a first output of the engine while operating the fuel injector according to the parameter, modifying operation of the fuel injector, detecting a second output of the engine responsive to modifying the operation of the fuel injector, and updating the parameter based on a comparison of the first output with the second output.

### TECHNICAL FIELD

The present disclosure relates generally to methods for calibrating fuel injection within internal combustion engines.

### BACKGROUND

Internal combustion engines can include, for example and without limitation, mono-fuel engine systems (e.g., using a single type of fuel) in addition to dual fuel engine systems that can operate using a combination of two different fuels. Such dual fuel engine systems can operate using a combination of a first fuel (e.g., a primary fuel), and optionally, a second fuel (e.g., a secondary fuel).

In an internal combustion engine system including a multi-cylinder engine (e.g., compression ignition or spark ignition internal combustion engines, etc.), fuel flow rates and fuel substitution rates (i.e., in the case of a dual fuel engine) can affect engine output. Improper fuel injection due to fuel injector drift can cause engine damage and/or decreased engine performance.

### SUMMARY

At least one embodiment relates to a method of fuel injector calibration for use with a fuel injector coupled with an engine. The method includes operating, based on a first target load for the engine, the fuel injector, according to a parameter for the fuel injector corresponding to the first target load, detecting a first output of the engine while operating the fuel injector according to the parameter, modifying operation of the fuel injector, detecting a second output of the engine responsive to modifying the operation of the fuel injector, and updating the parameter based on a comparison of the first output with the second output.

In some embodiments, the method includes operating the engine in a primary fuel only mode in which only the primary fuel is supplied to the engine. In some embodiments, the method includes operating the fuel injector based on the updated parameter. In some embodiments, the method includes modifying operation of the fuel injector includes disabling the fuel injector or operating the fuel injector at a partial level. In some embodiments, the method includes providing a first power output to compensate for a reduced engine power output during the modified operation of the fuel injector.

In some embodiments, the method includes operating, based on a second target load for the engine, the fuel injector coupled with the engine according to a parameter for the fuel injector corresponding to the second target load, modifying operation of the fuel injector, and providing a second power output to compensate for a reduced engine power output during the modified operation of the fuel injector. In some embodiments, the method includes detecting a third output of the engine responsive to modifying the operation of the fuel injector and updating the parameter based on a comparison of the second output with the third output. In some embodiments, updating the parameter comprises updating at least one of a function associated with the parameter or a lookup table associated with the parameter.

At least one embodiment relates to a calibration system for an engine and one or more fuel coupled to the engine. The calibration system includes a hybrid system and a controller. The hybrid system includes an electric motor and a battery each providing power. The controller is configured to operate, based on a first target load for the engine, an injector coupled with the engine according to a parameter for the injector corresponding to the first target load, modify operation of a first fuel injector of the one or more fuel injectors, control the electric motor to provide a power output based on the first target load and a modified engine power output caused by modifying the operation of the first fuel injector, determine a first power output associated with a fuel provided by the first fuel injector based on a difference between an actual engine power output determined before modifying the operation of the first fuel injector and an actual engine power output determined after modifying the operation of the first fuel injector, and operate the engine based on a second target load different than the first target load by reducing fueling of the first fuel injector to a target fueling level associated with the first target load, and controlling the electric motor to provide a power output based on the second target load and a reduced power output caused by reducing fueling of the first fuel injector.

In some embodiments, the engine is configured to be fueled by a primary fuel only. In some embodiments, the engine is configured to be fueled by a primary fuel and a secondary fuel.

In some embodiments, the controller is further configured to determine a variation between a maximum primary fuel injector power output value and a minimum primary fuel injector power output value, in response to the variation being greater than a first error margin, provide a signal indicating a fault, in response to the variation being greater than a second error margin, provide a signal to disable dual fuel operation of the engine, and in response to the variation being more than a third error margin, provide a signal to disable dual fuel operation of the engine and to de-rate engine power.

In some embodiments, the controller is further configured to determine a second primary fuel injector power output based on a difference between an actual engine power output determined before reducing fueling of the first fuel injector and an actual engine power output determined after reducing fueling of the first fuel injector and update the parameter based on the second primary fuel injector power output.

In some embodiments, the controller is further configured to determine a target power output, operate the engine to provide a set engine power output different from the target power output, control the electric motor to provide a power output based on the set engine power output and the target power output, determine a total fuel injector power output by comparing an actual engine power output and the set engine power output. In some embodiments, the controller is further configured to determine a first difference between the total fuel injector power output and the first fuel injector power output, determine a second difference between the total fuel injector power output and the second primary fuel injector power output, in response to at least one of the first difference or the second difference being greater than a first error margin, provide a signal indicating a fault. In some embodiments, the controller is further configured to in response to at least one of the first difference or the second difference being greater than a second error margin, provide a signal to disable dual fuel operation of the engine. In some embodiments, the controller is further configured to the controller is further configured to, in response to at least one of the first difference and the second difference being greater than a second error margin, provide a signal to de-rate engine power.

In some embodiments, the controller is further configured to, in response to the hybrid system operating in a dual fueling mode, operate the engine based on a third target load, disable a secondary fuel injector of the engine, and control the electric motor to provide a power output based on the third target load and a reduced engine power output caused by disabling the secondary fuel injector.

At least one embodiment relates to a method of calibrating fuel injection for a system including an engine. The method includes operating, based on a target load for the engine, a first fuel injector and a second fuel injector coupled with the engine according to a first parameter for the first fuel injector and a second parameter for the second fuel injector. The first parameter corresponds to a first fuel rate for the first fuel injector corresponding to the target load, and the second parameter corresponds to a second fuel rate for the second fuel injector corresponding to the target load. The method includes detecting a first output of the engine while operating the first fuel injector according to the first parameter and the second fuel injector according to the second parameter. The method includes modifying operation of the first fuel injector and the second fuel injector. The method includes comparing the first output with a second output of the engine detected after modifying the operation of the first fuel injector and the second fuel injector. The method includes updating the first parameter based on the comparison to determine an updated first parameter and the second parameter based on the comparison to determine an updated second parameter. The method includes operating the first fuel injector according to the updated first parameter and the second fuel injector according to the updated second parameter.

In some embodiments, modifying the operation of the first fuel injector and the second fuel injector includes increasing the first fuel rate on the first fuel injector, while simultaneously decreasing the second fuel rate on the second fuel injector.

In some embodiments, the system includes a hybrid system comprising an electric motor configured to provide power output. In such an embodiment, the method further includes providing, by the electric motor, a first power output to compensate for a reduced engine power output subsequent to disabling of the second fuel injector.

It should be appreciated that all combinations of the foregoing concepts and additional concepts discussed in greater detail below are contemplated as being part of the subject matter disclosed herein. In particular, all combinations of claimed subject matter appended at the end of this disclosure are contemplated as being part of the subject matter disclosed herein.

### BRIEF DESCRIPTION OF THE FIGURES

The foregoing and other features of the present disclosure will become more fully apparent from the following description and appended claims, taken in conjunction with the accompanying drawings. Understanding that these drawings depict only several implementations in accordance with the disclosure and are therefore, not to be considered limiting of its scope, the disclosure will be described with additional specificity and detail through use of the accompanying drawings.

FIG. 1 is a schematic diagram of a vehicle system, according to an exemplary embodiment.

FIG. 2 is a schematic diagram of a mono-fuel engine system, according to an embodiment.

FIG. 3 is a schematic diagram of a dual fuel engine system, according to an embodiment.

FIG. 4 is a schematic diagram of a controller for the dual fuel engine system of FIG. 3 or the mono-fuel engine system of FIG. 2, according to an embodiment.

FIG. 5 is a flow diagram of a method for calibrating fuel injection within an engine system, according to an embodiment.

FIG. 6 is a flow diagram of a method for calibrating fuel injection within the mono-fuel engine system of FIG. 2, based on engine operating condition measurement, according to an embodiment.

FIG. 7 is a flow diagram of a method for calibrating fuel injection within the mono-fuel engine system of FIG. 2, based on power measurement, according to an embodiment.

FIG. 8 is a flow diagram of a method for calibrating fuel injection within the dual fuel engine system of FIG. 1, according to an embodiment.

FIG. 9 is a flow diagram of another method for calibrating fuel injection within an engine system, according to an embodiment.

Reference is made to the accompanying drawings throughout the following detailed description. In the drawings, similar symbols typically identify similar components, unless context dictates otherwise. The illustrative implementations described in the detailed description, drawings, and claims are not meant to be limiting. Other implementations can be utilized, and other changes can be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and made part of this disclosure.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

Embodiments described herein relate generally to calibrations systems, such as for an engine and one or more fuel injectors coupled to the engine, methods of fuel injector calibration, such as for use with a fuel injector coupled with an engine, and methods for calibration fuel injector for a system including an engine. Such engines can be, for example, internal combustion engines. The internal combustion engines can be configured to operate using a first fuel (e.g., primary fuel), or a first fuel and a second fuel (e.g., secondary fuel).

In some embodiments, the first fuel can be a high cetane number fuel, such as diesel fuel, gas-to-liquid (GTL) diesel, heavy fuel oil (HFO), low sulfur fuel oil (LFSO), hydrotreated vegetable oil (HVO), marine gas oil (MGO), renewable diesel, biodiesel, paraffinic diesel, dimethyl ether (DME), F-76 fuel, F-34 fuel, jet A fuel, JP-4 fuel, JP-8 fuel, or oxymethylene ether (OME). The second fuel can be, for example, a low cetane number fuel (e.g., a high octane number fuel, a high methane number fuel, natural gas, hydrogen, bio-gas, commercially available gas, gasoline, methane, ethane, propane (LPG), butane, ethanol, producer gas, field gas, nominally treated field gas, ammonia, well gas, nominally treated well gas, syngas, liquefied natural gas (LNG), compressed natural gas, landfill gas, condensate, coal-bed methane (CBM)) or liquid fuels that are readily vaporized (e.g., gasoline, etc.). The second fuel can be a biofuel (e.g., a liquid biofuel, such as methanol and/or ethanol), an e-fuel, and/or a low carbon fuel. Biofuels and/or low carbon fuels can reduce the environmental impact of engine operation by reducing both particulate matter emissions and carbon dioxide relative to engines that operate using diesel fuel alone. The first fuel and/or the second fuel can optionally be a blend of fuels. It should be appreciated that the foregoing are merely examples of fuels, and other types of first and second fuels are not precluded.

The calibration system can include a hybrid system including an electric motor and a battery each providing power and a controller. In some embodiments, the one or more fuel injectors can refer to any fuel delivery device that can control the amount of fuel that is delivered. For example, the one or more fuel injectors can include a fuel flow control valve which adjusts the amount of fuel that is delivered either by adjusting how far the valve opens, or by how long or often the valve is opened. The controller can be configured to operate a first fuel injector of the one or more fuel injectors according to a parameter corresponding to a first target load for the engine, modify operation of the first fuel injector, control the electric motor to provide a power output based on the first target load and a modified engine power output caused by modifying the operation of the first fuel injector, determine a first power output associated with a fuel provided by the first fuel injector based on a difference between an actual engine power output determined before modifying the operation of the first fuel injector and an actual engine power output determined after modifying the operation of the first fuel injector, and operate the engine based on a second target load greater than the first target load. The controller can operate the engine by reducing fueling of the first fuel injector to a target fueling level associated with the first target load and controlling the electric motor to provide a power output based on the second target load and a reduced power output caused by reducing fueling of the first fuel injector. In some embodiments, the fuel injector power output can be defined as the engine power that results from the total amount of fuel that is injected. In some embodiments, a specified amount of engine power can be requested. This can be referred to as commanded fuel injector power output (e.g., the fuel injector is injecting fuel according to a fueling command which corresponds to a requested engine power). The engine can deliver mechanical power as a result of the actual amount of fuel that is delivered to the engine. This power can be referred to as an actual fuel injector power output (e.g., the actual engine power that results from the actual amount of fuel injected by the fuel injector).

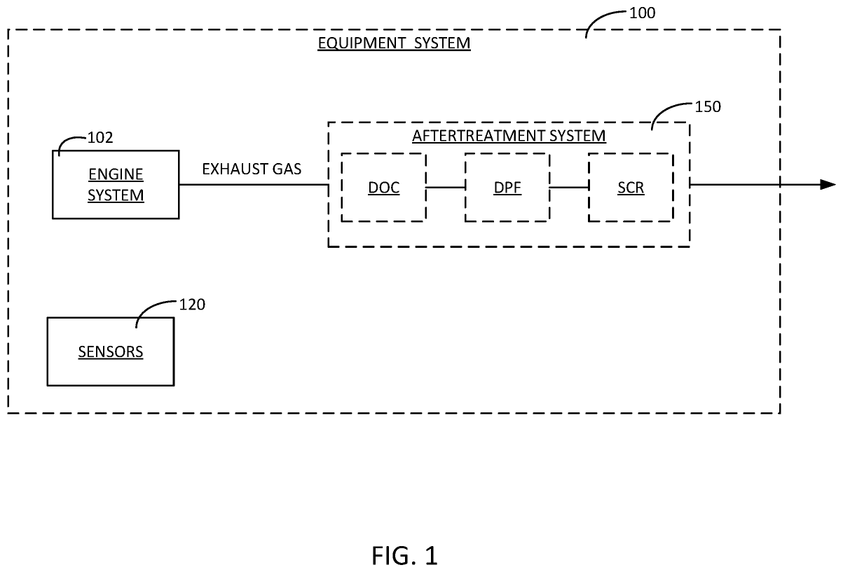

Referring now to FIG. 1, an example of an equipment system 100 is shown. The equipment system 100 can be included in a vehicle. The vehicle can be an on-road or an off-road vehicle including, but not limited to, a line-haul truck, mid-range truck (e.g., a pick-up truck), a car, boat, tank, aircraft, locomotive, mining equipment, and any other type of vehicle that can utilize systems to reduce emissions. The vehicle can include a powertrain system, a fueling system, an operator input/output device, one or more additional vehicle subsystems, etc. The vehicle can include additional, fewer, and/or different components/systems, as the principles of the present disclosure are intended to be applicable with a variety of vehicle configurations. It should also be understood that the principles of the present disclosure should not be interpreted to be limited to vehicles; rather, the present disclosure is also applicable to stationary pieces of equipment such as a power generator or a generator set (genset). The equipment system 100 is shown to include the engine system 102, an aftertreatment system 150 coupled with the engine system 102, a heater 110 coupled with the aftertreatment system 150, and sensors 120.

The engine system 102 as shown in FIG. 1 is structured as a compression-ignition internal combustion engine system. In various embodiments, the engine system 102 can be structured as any of various types of internal combustion engine systems (e.g., spark-ignition) that utilize any type of fuel (e.g., gasoline, natural gas). The engine system 102 can be or include an electric motor (e.g., a hybrid drivetrain).

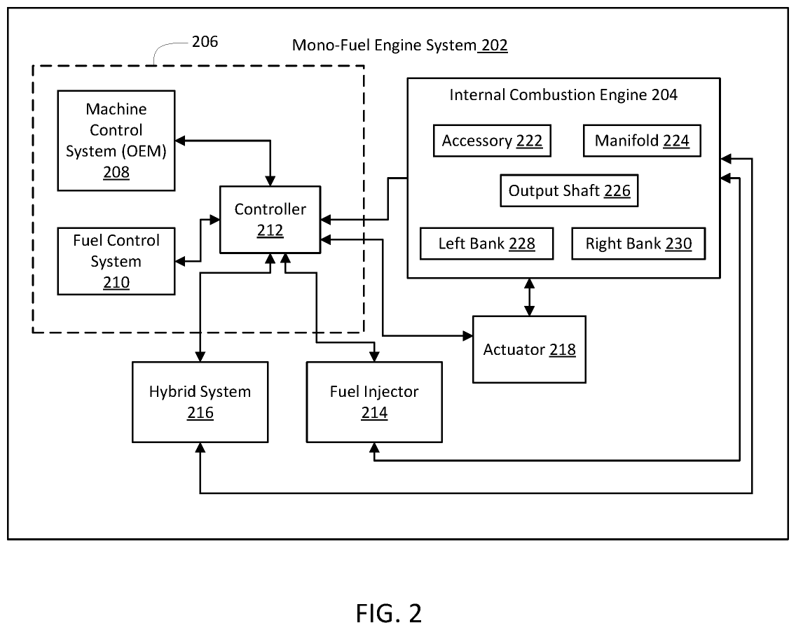

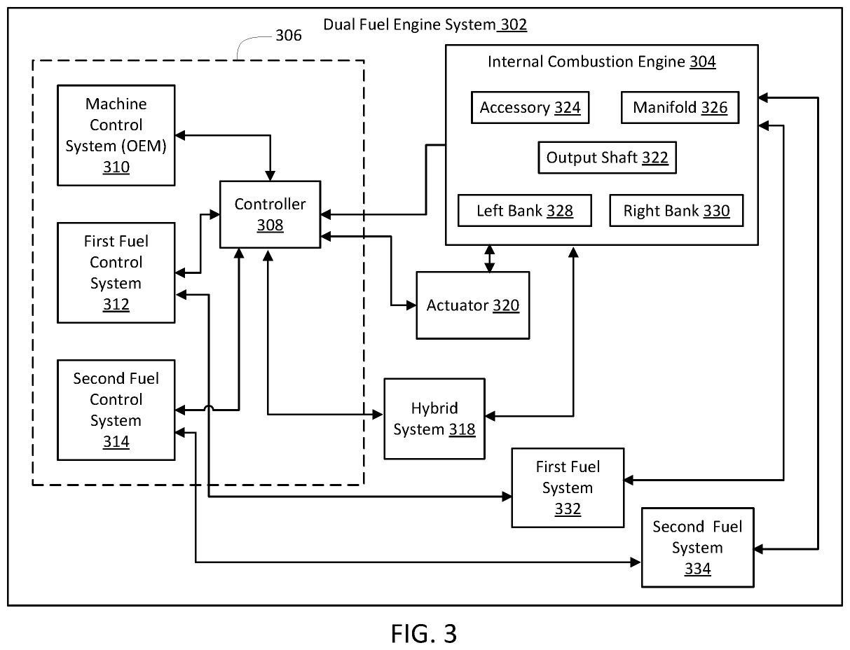

The engine system 102 includes one or more cylinders and associated pistons. Air from the atmosphere is combined with fuel, and combusted, to power the engine system 102. Combustion of the fuel and air in the combustion chambers within one or more cylinders of the engine system 102 produces exhaust gas that can be vented to an exhaust pipe and to the aftertreatment system. In some embodiments, the engine system 102 has a compression ratio representative of a target performance of the engine system 102 and/or the fuel to be used by the engine system 102. In some embodiments, the engine system 102 can be structured as a mono-fuel engine system as described in more detail below with regards to FIG. 2. In some embodiments, the engine system 102 can be structured as a dual fuel engine system as described in more detail below with regards to FIG. 3.

The aftertreatment system 150 is structured to receive exhaust gas from the engine system 102 and remove/mitigate harmful emissions from the exhaust gas before the exhaust gas is expelled to the environment. The aftertreatment system 150 can include one or more of a diesel oxidation catalyst (DOC), a diesel particulate filter (DPF), or a selective catalytic reduction (SCR). The arrangement of the DOC, DPF, and SCR shown in FIG. 1 is a non-limiting example.

The sensors 120 are coupled with a controller associated with the equipment system 100 (or of other systems/components of the associated vehicle). The controller is described in more detail with respect to FIGS. 2-4. The sensors are configured to detect and/or determine values associated with various properties of the equipment system 100 and vehicle. Accordingly, the sensors 120 can include one or more of a temperature sensor, a particulate matter sensor, an emission sensor, a vibration sensor, a noise sensor, an engine speed sensor, a vehicle speed sensor, an engine torque sensor and one or more sensors for a fueling system. The temperature sensor can be, for example, a thermocouple or a resistance temperature detector to determine a temperature of one or more of the intake air, coolant, oil temperatures, or exhaust gas, for example. The particulate matter sensor can be configured to sense the amount of particulate matter in the exhaust gas. The emission sensor can be configured to determine a proportion of oxygen and nitrous oxides in the exhaust gas, which is indicative of the level of harmful emissions in the exhaust gas and thus the efficiency of the engine. The sensors for the fueling system can be provided to determine a fuel injected quantity or a rail pressure, for example. In some embodiments, certain of the sensors 120 are combined into a single sensor. In some embodiments, the sensors 120 are separate sensors. In some embodiments, a plurality of sensors (e.g., a plurality of temperature sensors, a plurality of particulate matter sensors, and/or a plurality of emission sensors) can be used.

Referring to FIG. 2, a block diagram of an example of a mono-fuel engine system 202 is shown. The mono-fuel engine system 202 is an engine having a single fuel operation mode (e.g., is to operate using only a single fuel or blend of fuels received from a single source). The fuel can be, for example, the first fuel (or, in some embodiments, the second fuel) as described above.

As shown in FIG. 2, the mono-fuel engine system 202 includes an internal combustion engine 204, which is operably coupled with a control system 206 via at least one controller 212. The mono-fuel engine system 202 can include a hybrid system 216. The hybrid system 216 can be configured to generate power in the mono-fuel engine system 202. In some embodiments, the hybrid system 216 can be used to compensate for power that engine 204 cannot provide in response to a power request. In some embodiments, the hybrid system 216 can include a battery and an electric machine. In some embodiments, the engine 204 is a mono-fuel engine. The control system 206 can include at least one of a machine control system (OEM system) 208 or a fuel control system 210. The control system 206 can send one or more inputs to the controller 212, responsive to which the controller 212 can control the internal combustion engine 204. In various embodiments, the fuel control system 210 and its components are configured to operate using the fuel. In some embodiments, the fuel control system can be a gas fuel control system. In some embodiments, the fuel control system can be a liquid fuel control system. In various embodiments, the fuel control system 210 cooperatively operates within the internal combustion engine 204. In some embodiments, the internal combustion engine 204 is configured to be fueled by a primary fuel only.

In various embodiments, the controller 212 is configured to include a processor and a non-transitory computer readable medium (e.g., a memory device) having computer-readable instructions stored thereon that, when executed by the processor, cause the at least one controller 212 to carry out one or more operations. In various embodiments, the at least one controller 212 is a computing device (e.g., a microcomputer, microcontroller, or microprocessor). In some embodiments, the at least one controller 212 is configured as part of a data cloud computing system configured to receive commands from a user control device and/or remote computing device.

The controller 212 can include one or more processors and a memory. The one or more processors can include a microprocessor, an application-specific integrated circuit (ASIC), a field-programmable gate array (FPGA), etc., or combinations thereof. The memory can include, but is not limited to, electronic, optical, magnetic, or any other storage or transmission device capable of providing a processor, ASIC, FPGA, etc. with program instructions. The memory can include a memory chip, Electrically Erasable Programmable Read-Only Memory (EEPROM), Erasable Programmable Read Only Memory (EPROM), flash memory, or any other suitable memory from which the controller can read instructions. The instructions can include code from any suitable programming language. The memory can include various modules that include instructions which are configured to be executed or otherwise implemented by the one or more processors. The subject matter including the operations described in this specification can be implemented in other types of digital electronic circuitry, or in computer software, firmware, or hardware, including the structures disclosed in this specification and their structural equivalents, or in combinations of one or more of them. The one or more processor and/or memory can be implemented as hardware for performing operations other than control operations, including but not limited to any of various data storage, communication, and/or processing operations.

The controller 212 can be at least partially implemented by or can be communicably coupled with any of various control hardware (not shown) associated with operation of the mono-fuel engine system 202, including but not limited to an engine control unit (ECU) or engine control module (ECM). In some embodiments, the controller 212 can receive or detect one or more signals, such as electrical signals or electronic signals, regarding operation of the mono-fuel engine system 202.

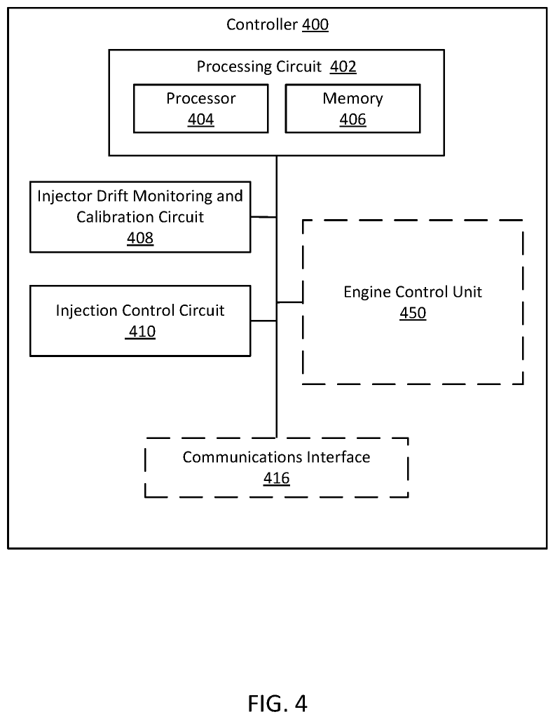

The controller 212 can be operably coupled with the at least one fuel injector 214 to facilitate injection of the fuel. The controller 212 can be operably coupled with and at least one actuator 218. In some embodiments, the fuel injector 214 is a gas injector. In some embodiments, the fuel injector 214 is a liquid fuel injector. In some embodiments, each of the fuel injector 214, and the actuator 218 are operably coupled with the internal combustion engine 204. In some embodiments, the hybrid system 216 can be operably coupled to the internal combustion engine 204. In other embodiments, the hybrid system 216 can be arranged such that it is not directly coupled to the internal combustion engine 204. In various embodiments, the fuel injector 214 is configured to control or facilitate injection of the fuel (e.g., gas or a liquid, or a second gas) into the internal combustion engine 204. The actuator 218 can include one or more first fuel type (e.g., diesel type or other liquid type, first gas type) actuators, air handling actuators, aftertreatment actuators, or any other type of actuator within the mono-fuel engine system 202. Accordingly, during operation, the controller 212 can send one or more inputs to one or more of the internal combustion engine 204, the fuel injector 214, the hybrid system 216, or the actuator 218 to facilitate operating the mono-fuel engine system 202 in a target mode of operation. The controller 212 is described in more detail with respect to FIG. 4.

As shown, the internal combustion engine 204 includes an output shaft 226 and can also include one or more accessories 222. The internal combustion engine 204 further includes at least one manifold 224. In various embodiments, the at least one manifold 224 includes, but is not limited to an intake manifold. The internal combustion engine 204 also includes at least one engine cylinder bank. In some embodiments, the at least one engine cylinder bank includes a left bank 228 and a right bank 230. During operation of the mono-fuel engine system 202, the control system 206 can receive one or more inputs from a user and/or one or more sensors within the mono-fuel engine system 202 and control operation of at least one of the internal combustion engine 204, the fuel injector 214, or the actuator 218 via the controller 212.

Referring to FIG. 3, a block diagram of a dual fuel engine system 302 is shown, according to an exemplary embodiment. The dual fuel engine system 302 is configured to be an engine having a dual fuel operation mode, such as in which the engine is configured to operate using two different fuels. The engine can be configured to operate using a first fuel and a second fuel (e.g., as described above), where the first fuel and the second fuel have different properties and/or chemical compositions. The properties can include auto-ignition temperatures, flame speeds, etc. The fuels can include diesel and natural gas, as an example. In various embodiments, the dual fuel engine system 302 is configured for one or more oil and gas production applications (e.g., land based oil and/or gas drilling and hydraulic fracturing).

As shown in FIG. 3, the dual fuel engine system includes an internal combustion engine 304, which is operably coupled with a control system 306 via at least one controller 308. The control system 306 can include a machine control system 310. The machine control system can be a control system from an original equipment manufacturer (an OEM system). The control system 306 can further include a first fuel control system 312, and a second fuel control system 314, is configured to send one or more inputs to the controller 308, where the controller 308 then controls the internal combustion engine 304. The engine system 302 can include a hybrid system 316. The hybrid system 316 can be configured to generate power in the engine system 302. In some embodiments, the hybrid system 316 can be used to compensate for power that engine 304 cannot provide in response to a power request.

In some embodiments, the hybrid system 316 can include a battery and an electric machine. In various embodiments the first fuel control system 312 is configured to control a first fuel system 332. The first fuel system 332 and its components are configured to operate using the first fuel. The first fuel system 332 is a fuel delivery system which can include one or more fuel injectors configured to inject the first fuel into the internal combustion engine 304. In some embodiments, the second fuel control system 314 is configured to control a second fuel system 334. The second fuel system 334 and its components are configured to operate using the second fuel. The second fuel system 334 is a fuel delivery system which can include one or more fuel injectors configured to inject the second fuel into the internal combustion engine 304. In some embodiments, the one or more fuel injectors are gas injectors. In some embodiments, the one or more fuel injectors are liquid fuel injectors. For example, in various embodiments, the first fuel control system 312 is a diesel control system and the second fuel control system 314 is a gas control system. In some embodiments, the first fuel control system 312 is a first gas control system and the second fuel control system 314 is a second gas control system. In some embodiments, one or both of the first fuel control system 312 and the second fuel control system 314 can be liquid fuel control systems. In some embodiments, the internal combustion engine 304 can be configured to be fueled by a primary and secondary fuel.

In some embodiments, each of the first fuel control system 312 and the second fuel control system 314 and their respective components can selectively operate using either the first fuel or the second fuel. In various embodiments, the first fuel control system 312 and the second fuel control system 314 cooperatively operate within the internal combustion engine 304.

In various embodiments, the controller 308 is configured to include a processor and a non-transitory computer readable medium (e.g., a memory device) having computer-readable instructions stored thereon that, when executed by the processor, cause the at least one controller 308 to carry out one or more operations. In various embodiments, the at least one controller 308 is a computing device (e.g., a microcomputer, microcontroller, or microprocessor). In some embodiments, the at least one controller 308 is configured as part of a data cloud computing system configured to receive commands from a user control device and/or remote computing device.

The controller 308 can include one or more processors and a memory. The one or more processors can include a microprocessor, an application-specific integrated circuit (ASIC), a field-programmable gate array (FPGA), etc., or combinations thereof. The memory can include, but is not limited to, electronic, optical, magnetic, or any other storage or transmission device capable of providing a processor, ASIC, FPGA, etc. with program instructions. The memory can include a memory chip, Electrically Erasable Programmable Read-Only Memory (EEPROM), Erasable Programmable Read Only Memory (EPROM), flash memory, or any other suitable memory from which the controller can read instructions. The instructions can include code from any suitable programming language. The memory can include various modules that include instructions which are configured to be executed or otherwise implemented by the one or more processors. The subject matter including the operations described in this specification can be implemented in other types of digital electronic circuitry, or in computer software, firmware, or hardware, including the structures disclosed in this specification and their structural equivalents, or in combinations of one or more of them. The one or more processor and/or memory can be implemented as hardware for performing operations other than control operations, including but not limited to any of various data storage, communication, and/or processing operations.

The controller 308 can be at least partially implemented by or can be communicably coupled with any of various control hardware (not shown) associated with operation of the engine system 302, including but not limited to an engine control unit (ECU) or engine control module (ECM). In some embodiments, the controller 308 can receive or detect one or more signals, such as electrical signals or electronic signals, regarding operation of the engine system 302.

The following description generally relates to a system in which the first fuel control system 312 operates using the first fuel and the second fuel control system 314 operates using the second fuel, however, it should be understood that in some embodiments, each of the first and second fuel control system 312, 314 can be selectively configured to operate using either the first fuel or the second fuel, as described above. The controller 308 can be operably coupled with and at least one actuator 320. In some embodiments, each of the hybrid system 316 and the actuator 320 are operably coupled with the internal combustion engine 304. The actuator 320 can include one or more first fuel type (e.g., diesel type or other liquid type, first gas type) actuators, air handling actuators, aftertreatment actuators, or any other type of actuator within the dual fuel engine system 302. Accordingly, during operation, the controller 308 can send one or more inputs to one or more of the internal combustion engine 304, the hybrid system 316, or the actuator 320 to facilitate a target mode of operation of the dual fuel engine system 302. The controller 308 is described in more detail with respect to FIG. 4.

As shown, the internal combustion engine 304 includes an output shaft 322 and can also include one or more accessories 324. The internal combustion engine 304 further includes at least one manifold 326. In various embodiments, the at least one manifold 326 includes, but is not limited to an intake manifold. The internal combustion engine 304 also includes at least one engine cylinder bank. In some embodiments, the at least one engine cylinder bank includes a left bank 328 and a right bank 333. During operation of the dual fuel engine system 302, the control system 306 can receive one or more inputs from a user and/or one or more sensors within the dual fuel engine system 302. The control system 306 can control operation of at least one of the internal combustion engine 304 or the actuator 320 via the controller 308.

Referring to FIG. 4, a schematic diagram of a controller 400 is shown, according to an embodiment. The controller 400 or one or more components thereof can be included in and/or used to implement one or more devices described herein, e.g., the controller 212 and/or the controller 308. The controller 400 can be structured as one or more electronic control units (ECUs). In some embodiments, the controller 400 includes multiple sub-controllers. In some embodiments, the controller 400 is a distributed controller. As such, the controller 400 can be separate from or included with an engine control unit (e.g., an ECU for the engine system 202 and/or the engine system 302. The controller 400 is configured to communicate with one or more subcomponents of the engine systems 202, 302, including through direct communication, communication over a datalink, and/or through communication with other controllers or portions of the processing subsystem that provide information to the controller 400.

The controller 400 includes a processing circuit 402 having a processor 404 and a memory 406. The controller 400 can include an injector drift monitoring and calibration circuit 208 to determine whether one or more fuel injectors has drifted. The controller 400 can include an injection control circuit 410 configured to determine an adjusted start of injection (SOI) or an adjusted amount of fuel injected by the fuel injectors. In some embodiments, the controller 400 additionally includes a communications interface 416 that communicably couples the controller 400 to various other components of the equipment system 100.

In one configuration, the injector drift monitoring and calibration circuit 208 and the injection control circuit 410 are configured by computer-readable media that are executable by a processor, such as the processor 404. As described herein and amongst other uses, the circuitry facilitates performance of certain operations to enable reception and transmission of data. For example, the circuitry can provide an instruction (e.g., command, etc.) to, e.g., acquire data. In this regard, the circuitry can include programmable logic that defines the frequency of acquisition of the data and/or other aspects of the transmission of the data. In particular, the circuitry can be implemented by computer readable media which can include code written in any programming language including, but not limited to, Java, JavaScript, Python or the like and any conventional procedural programming languages, such as the “C” programming language or similar programming languages. The computer readable program code can be executed on one processor or multiple remote processors. In the latter scenario, the remote processors can be connected to each other through any type of network (e.g., a controller area network (CAN) bus, etc.).

In some embodiments, a non-transitory processor-readable medium stores code representing instructions to be executed by one or more processors 404, the instructions comprising code to cause the one or more processors 404 to: operate, based on a first target load for the engine, an injector coupled with the engine (e.g., engine 204 or engine 304) according to a parameter for the injector corresponding to the first target load, modify operation of a first fuel injector of the one or more fuel injectors, control the electric motor to provide a power output based on the first target load and a modified engine power output caused by modifying the operation of the first fuel injector, determine a first power output associated with a fuel provided by the first fuel injector based on a difference between an actual engine power output determined before modifying the operation of the first fuel injector and an actual engine power output determined after modifying the operation of the first fuel injector, and operate the engine based on a second target load different than the first target load by: reducing fueling of the first fuel injector to a target fueling level associated with the first target load, and controlling the electric motor to provide a power output based on the second target load and a reduced power output caused by reducing fueling of the first fuel injector.

In some embodiments, the controller 400 can be further configured to determine a variation between a maximum primary fuel injector power output value and a minimum primary fuel injector power output value, in response to the variation being greater than a first error margin, provide a signal indicating a fault, in response to the variation being greater than a second error margin, provide a signal to disable dual fuel operation of the engine, and in response to the variation being more than a third error margin, provide a signal to disable dual fuel operation of the engine and to de-rate engine power. In some embodiments, any other action can be taken to address the errors or margin. In some embodiments, the controller 400 can be configured to, in response to the hybrid system operating in a dual fueling mode: operate the engine based on a third target load, disable a secondary fuel injector of the engine, and control the electric motor to provide a power output based on the third target load and a reduced engine power output caused by disabling the secondary fuel injector.

In some embodiments, the controller 400 can be configured to determine a second primary fuel injector power output based on a difference between an actual engine power output determined before reducing fueling of the first fuel injector and an actual engine power output determined after reducing fueling of the first fuel injector and update the parameter based on the second primary fuel injector power output. In some embodiments, the controller 400 can be further configured to: determine a target power output, operate the engine to provide a set engine power output different from the target power output, control the electric motor to provide a power output based on the set engine power output and the target power output, and determine an estimated fuel injector power output by comparing an actual engine power output and the set engine power output. The target power output can be the power that is requested by the operator or the controller 400. The controller 400 can control the electric motor to provide a power output that is determined based on an actual amount of power being delivered. The actual amount of power can be determined based on the measured current and/or voltage associated with the electric motor. In some embodiments, the controller 400 can be further configured to determine a first difference between the total fuel injector power output and the first fuel injector power output, determine a second difference between the total fuel injector power output and the second primary fuel injector power output, and in response to at least one of the first difference or the second difference being greater than a first error margin, provide a signal indicating a fault. In some embodiments, the controller 400 can be configured to, in response to at least one of the first difference or the second difference being greater than a second error margin, provide a signal to disable dual fuel operation of the engine. In some embodiments, the controller 400 can be configured to, in response to at least one of the first difference and the second difference being greater than a second error margin, provide a signal to de-rate engine power.

In some embodiments, the injector drift monitoring and calibration circuit 208 and the injection control circuit 410 are embodied as hardware units, such as electronic control units. As such, the injector drift monitoring and calibration circuit 208 and the injection control circuit 410 can be embodied as one or more circuitry components including, but not limited to, processing circuitry, network interfaces, peripheral devices, input devices, output devices, sensors, etc.

In some embodiments, the injector drift monitoring and calibration circuit 208 and the injection control circuit 410 can take the form of one or more analog circuits, electronic circuits (e.g., integrated circuits (IC), discrete circuits, system on a chip (SOCs) circuits, microcontrollers, etc.), telecommunication circuits, hybrid circuits, and any other type of “circuit.” In this regard, the injector drift monitoring and calibration circuit 208 and the injection control circuit 410 can include any type of component for accomplishing or facilitating achievement of the operations described herein. For example, a circuit as described herein can include one or more transistors, logic gates (e.g., NAND, AND, NOR, OR, XOR, NOT, XNOR, etc.), resistors, multiplexers, registers, capacitors, inductors, diodes, wiring, and so on.

The injector drift monitoring and calibration circuit 208 and the injection control circuit 410 can also include programmable hardware devices such as field programmable gate arrays, programmable array logic, programmable logic devices or the like. In this regard, the injector drift monitoring and calibration circuit 208 and the injection control circuit 410 can include one or more memory devices for storing instructions that are executable by the processor(s) of the injector drift monitoring and calibration circuit 208 and the injection control circuit 410. The one or more memory devices and processor(s) can have the same definition as provided below with respect to the memory 406 and the processor 404. Thus, in this hardware unit configuration, the injector drift monitoring and calibration circuit 208 and the injection control circuit 410 can be dispersed throughout separate locations in the engine system (e.g., as separate control units, etc.). In some embodiments, such as depicted in FIG. 4, the injector drift monitoring and calibration circuit 208 and the injection control circuit 410 can be provided in a single unit/housing, shown as the controller 212, 308.

In the example shown, the processing circuit 402 can be configured to execute or implement the instructions, commands, and/or control processes described herein with respect to one or more of the injector drift monitoring and calibration circuit 208 and the injection control circuit 410. Thus, the depicted configuration represents the aforementioned arrangement where one or more of the injector drift monitoring and calibration circuit 208 and the injection control circuit 410 are embodied as machine or computer-readable media. However, the present disclosure further contemplates embodiments where one or more of the injector drift monitoring and calibration circuit 208 and the injection control circuit 410, or at least one circuit of the injector drift monitoring and calibration circuit 208 and the injection control circuit 410, are configured as hardware. All such combinations and variations are intended to fall within the scope of the present disclosure.

The processor 404 can be implemented as one or more general-purpose processors, an application specific integrated circuit (ASIC), one or more field programmable gate arrays (FPGAs), a digital signal processor (DSP), a group of processing components, or other suitable electronic processing components. In some embodiments, the processor 404 is shared by multiple circuits (e.g., the injector drift monitoring and calibration circuit 208 and the injection control circuit 410 can include or otherwise share the same processor 404 which, in some example embodiments, can execute instructions stored, or otherwise accessed, via different areas of memory 406).

Alternatively, or in combination, the processor 404 can be one of a plurality of processors that is configured to perform or otherwise execute certain operations independent of one or more co-processors. In other example embodiments, two or more processors can be coupled via a bus to enable independent, parallel, pipelined, or multi-threaded instruction execution. All such variations are intended to fall within the scope of the present disclosure.

The memory 406 (e.g., RAM, ROM, Flash Memory, hard disk storage, etc.) can store data and/or computer code for facilitating the various processes described herein. The memory 406 can be communicably connected to the processor 404 to provide computer code or instructions to the processor 404 for executing at least some of the processes described herein. Moreover, the memory 406 can be or include tangible, non-transient volatile memory or non-volatile memory. Accordingly, the memory 406 can include database components, object code components, script components, or any other type of information structure for supporting the various activities and information structures described herein.

The communications interface 416 can include wired and/or wireless interfaces (e.g., jacks, antennas, transmitters, receivers, transceivers, wire terminals, etc.) for conducting data communications with various components of the engine system. For example, the communications interface 416 can include an Ethernet card and port for sending and receiving data via an Ethernet-based communications network and/or a Wi-Fi transceiver for communicating via a wireless communications network. The communications interface 416 can be structured to communicate via local area networks or wide area networks (e.g., the Internet, etc.) and can use a variety of communications protocols (e.g., IP, local area network (LAN), controller area network (CAN), J1939, local interconnect network (LIN), Bluetooth, ZigBee, radio, cellular, near field communication, etc.).

The communications interface 416 of the controller 212, 308 is configured to facilitate communication between and amongst the controller 212, 308 and various components of the engine systems 202 and 302. The communications interface 416 is configured to coordinate the transmission and reception of data between the controller 212, 308, sensors, a human-machine interface (e.g., operator input/output (I/O)), and the components of the engine system that are configured to enable control operation of fuel injection events, including the delivery of fuel to combustion chambers in the engine.

Certain operations described herein include operations to interpret and/or to determine one or more operation parameters. Interpreting or determining, as utilized herein, can include one or more of receiving values from a datalink or network communication, receiving an electronic signal (e.g. a voltage, frequency, current, or PWM signal) indicative of the value, receiving a computer generated operation parameter indicative of the value, reading the value from a memory location on a non-transient computer readable storage medium, receiving the value as a run-time operation parameter by any means known in the art, receiving a value by which the interpreted operation parameter can be calculated, or referencing a default value that is interpreted to be the operation parameter value.

The injector drift monitoring and calibration circuit 408 can be configured to monitor and actual engine power, compare the actual engine power to a target or expected engine power based on a commanded injection event, and adjusting calibration of the fuel injectors based on this comparison. In some embodiments, the drift monitoring and calibration circuit 408 is configured to receive sensor input (e.g., sensor data from a sensor or combination of sensors suitable to provide an output of current engine power output). For example, the drift monitoring and calibration circuit 408 can receive sensor data from one or more of a multimeter sensor, an engine speed sensor, or a dynamometer, among other sensors. In some embodiments, when the internal combustion engine 204 drives an alternator or generator, the injector drift monitoring and calibration circuit 408 can monitor the electrical power from the alternator or generator. In some embodiments, when the internal combustion engine 204 drives a pump, the injector drift monitoring and calibration circuit 408 can monitor the pump discharge rate and the flow rate through the pump to estimate the power. The flow rate can be estimated from the pump RPM. In some embodiments, the injector drift monitoring and calibration circuit 408 can monitor the brake power of the engine with a torque meter and an engine speed sensor. In some embodiments, the injector drift monitoring and calibration circuit 408 can estimate the power to drive one or more accessories. The one or more accessories can include, but are not limited to, a cooling fan or a hydraulic pump. The power associated with driving the one or more accessories can be measured or estimated separately. In some embodiments, the controller 400 determines the power of the engine to include power for driving the one or more accessories.

In some embodiments, the injector drift monitoring and calibration circuit 208 is configured to receive a calibration parameter or table of calibration parameters. The calibration parameter or table associates the power output of the engine as a function of a commanded injection amount. The injector drift monitoring and calibration circuit 208 can be configured to monitor the power output of the engine to determine whether the calibration parameter is accurate and update the calibration power based on that determination. For example, the injection control circuit 410 can determine an adjustment to the start of injection or the amount of injection based on the updated calibration table.

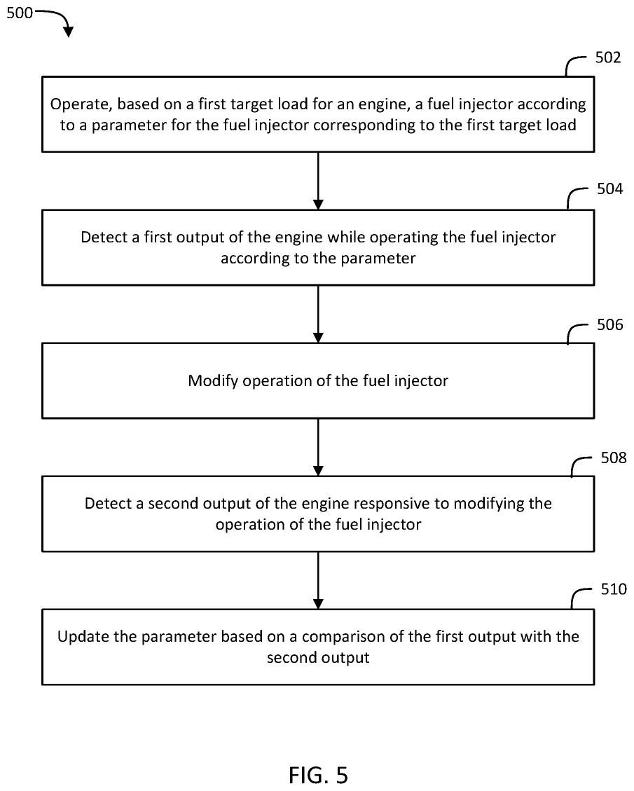

FIG. 5 shows a flow diagram of a method 500, such as for fuel injector calibration for use with a fuel injector coupled with an engine system, according to exemplary embodiment. The method 500 can be implemented on any of the engine systems described herein, such the mono-fuel engine system 202 and the dual fuel engine system 302 described with reference to FIGS. 2-3. The method 500 includes: operating the fuel injector according to a parameter for the fuel injector that corresponds to a first target load for the engine, detecting a first output of the engine while operating the fuel injector according to the parameter; modifying operation of the fuel injector; detecting a second output of the engine responsive to modifying the operation of the fuel injector; and updating the parameter based on a comparison of the first output with the second output. In some embodiments, modifying operation of the fuel injector includes disabling the fuel injector or operating the fuel injector at a partial level. In some embodiments, updating the parameter includes updating at least one of a function associated with the parameter or a lookup table associated with the parameter. In some embodiments, the parameter is the calibration parameter described above.

In some embodiments, the method 500 can further include operating the engine in a primary fuel only mode in which only the primary fuel is supplied to the engine. In some embodiments, the method 500 can further include operating the fuel injector based on the updated parameter. In some embodiments, the method 500 further includes modifying operation of the fuel injector, which can include, for example, disabling the fuel injector or operating the fuel injector at a partial level relative to a maximum operating capacity of the fuel injector. In another embodiment, the method 500 can include modifying operation of more than one fuel injector at a time.

In some embodiments, the method 500 includes providing a first power output to compensate for a reduced engine power output during the modified operation of the fuel injector. For example, the method 500 can include operating, based on a second target load for the engine, the fuel injector coupled with the engine according to a parameter for the fuel injector corresponding to the second target load, modifying the operation of the fuel injector, and providing a second power output to compensate for a reduced engine power output during the modified operation of the fuel injector. In such an embodiment, the method 500 can further include detecting a third output of the engine responsive to modifying the operation of the fuel injector; and updating the parameter based on a comparison of the second output with the third output. In some embodiments, the engine systems includes two sources of mechanical power (e.g., an internal combustion engine and an electric motor coupled to a battery) which can be used to provide power to compensate for a reduced engine power. Specifically, the electric motor can convert electrical power to mechanical power. When run as a generator, the motor-generator can convert mechanical power into electrical power. The electrical power can be transferred to the battery.

Operation 502 includes operating the fuel injector according to a parameter for the fuel injector that corresponds to a first target load for the engine. Operation 502 can include actuating or causing a fuel injector to release a certain amount of fuel into the combustion chamber of an engine based on a first target load for an engine. In some embodiments, the amount of fuel injected can be determined according to a parameter (e.g., calibration parameter) for the fuel injector corresponding to the first target load. For example, the parameter and/or a table (e.g., lookup table) representing the parameter can indicate a value (e.g., voltage, etc.) of a control signal to provide to the fuel injector to cause the fuel injector to output fuel at a commanded fuel injection rate.

Operation 504 includes detecting a first output of the engine while operating the fuel injector according to the parameter. Specifically, operation 504 can include determining a first power output of the engine while operating the fuel injector according to the parameter as described above at operation 502.

Operation 506 includes modifying the operation of the fuel injector. In some embodiments, modifying the operation of the fuel injector can include decreasing the amount of fuel provided by the fuel injector. In some embodiments, modifying the operation of the fuel injector can include disabling the fuel injector (e.g., such that the fuel injector does not provide any fuel). In some embodiments, the method 500 can further include providing a first power output to compensate for a reduced engine power output during the modified operation of the fuel injector.

Operation 508 includes detecting a second output of the engine responsive to modifying the operation of the fuel injector. Specifically, operation 508 can include determining a second power output of the engine while operating the fuel injector in its modified condition.

Operation 510 includes updating the parameter based on a comparison of the first output with the second output. In some embodiments, comparing the first output and the second output can indicate the amount fuel being injected by the modified fuel injector by determining the difference in power output by the engine when the fuel injector is fully operating and when the fuel injector is disabled or partially used. Based on this comparison, a magnitude of a difference can be determined between the output of the engine expected given the commanded fuel rate and an actual output of the engine, such as to characterize the performance of the fuel injector and/or compare the difference to a threshold to determine to adjust operation of the fuel injector responsive to the difference exceeding the threshold.

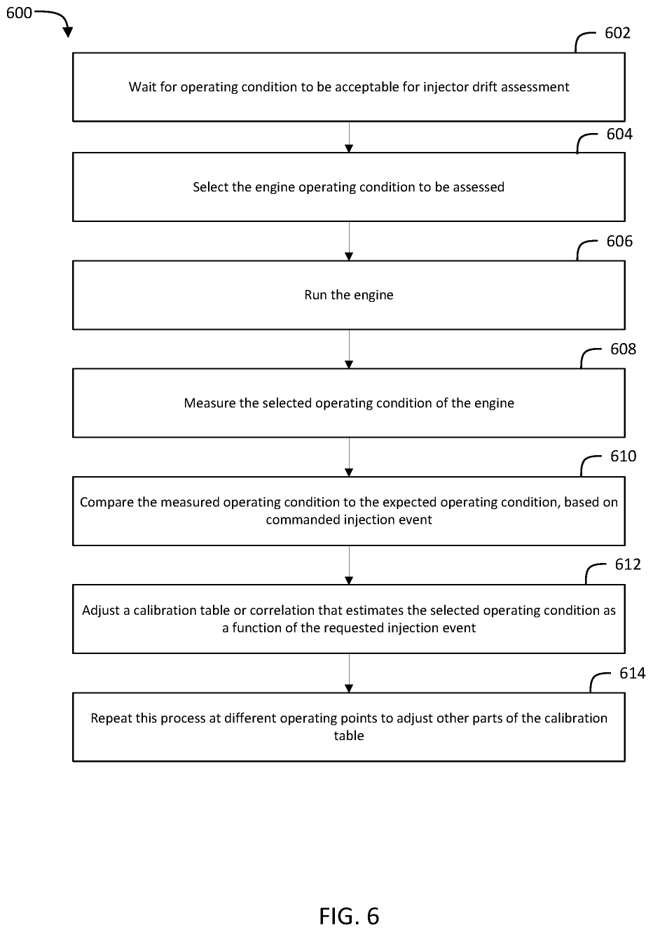

FIG. 6 shows a flow diagram of a method 600 for calibrating fuel injection within an engine system is shown according to exemplary embodiment. The method 600 can be implemented on any of the engine systems described herein, such the mono-fuel engine system 202. The method 600 can include monitoring whether an operating condition is acceptable for injector drift assessment; selecting the specific engine operating condition to be assessed; running the engine; measuring actual engine power; comparing the actual engine power to the expected engine power, based on commanded injection event; adjusting a table or correlation to estimate engine power as a function of the requested injection event; and repeating the process at different operating points to adjust the calibration table.

Upon determining that assessment of injector drift is to be performed, the method 600 begins at operation 602. Operation 602 includes monitoring whether an operating condition or parameter is acceptable for injector drift assessment. In some embodiments, the operating condition can include the engine temperature being above a target threshold. In some embodiments, the operating condition can include the engine being at a speed/load point of interest. This can be a given load or speed, or another operation parameter. In some embodiments, the operating condition can be a transient state of the engine. The transient state can be associated with at least one of engine speed or engine power remaining substantially constant for a specified duration. In some embodiments, determining the operating condition can include comparing the target operating condition to the current operating condition to ensure there is enough power from the hybrid system to meet the total power requested by the vehicle. In some embodiments, the operating condition can include determining when the last time the injector drift was assessed. For example, the controller can assess the injector drift at certain predetermined intervals (e.g., every 24 hours, every 48 hours, every week, etc.).

In some embodiments, the controller can abort the assessment of the injector drift. For example, the controller 400 can determine to abort the assessment when there is a requirement for full power after engine is running at a lower load and an assessment is in progress. The controller 400 can determine to complete the assessment at a given time following the aborting. In some embodiments, the assessment can be conducted during a scheduled maintenance event for the vehicle.

Operation 604 includes selecting the engine operating condition to be assessed. For example, in some embodiments, the power output of the engine can be selected as the operating condition to be assessed. As another example, the speed of the engine can be selected as the operating condition to be assessed.

Operation 606 includes running the engine. In some embodiments, the engine can be run at a steady state. In some embodiments, the engine can be run using only a first or primary fuel at operation 606. The engine can be commanded to produce an amount of power to meet a requested power demand. In some embodiments, where the engine is unable to meet the requested power demand, the hybrid system can provide a difference between the requested power demand the engine power output.

Operation 608 includes measuring the selected operating condition of the engine which was selected at operation 604. For example, when the selected operating condition is engine power, the actual engine power output is measured at operation 608. As another example, when the selected operating condition is engine speed, the actual engine speed is measured at operation 608.

Operation 610 includes comparing the measured operating condition to the expected operating condition, based on the commanded injection event. The expected operating condition can be based on a calibration table or parameter which can be stored in the controller of the engine. In some embodiments, comparing the measured operating condition with the expected operating condition can indicate the amount fuel being injected by the one or more fuel injectors by determining the difference in the operating condition of the engine compared to the expected operating condition. Based on the comparison between the measured operating condition and the expected operating condition, a magnitude of a difference between the actual operation of the fuel injector and the targeted operation (e.g., commanded fuel rate) can be determined.

Operation 612 includes adjusting a table or correlation that estimates the selected operating condition as a function of the requested injection event. Specifically, the table or correlation can be referred herein as the calibration parameter. The calibration parameter can be adjusted based on the comparison made at operation 610. For example, when the comparison at operation 610 yields a difference between the measured operating conditions and the expected operating condition below a certain threshold, the calibration parameter cannot be updated. In contrast, when the comparison at operation 610 yields a difference between the measured operating conditions and the expected operating condition above a certain threshold, the calibration parameter can be updated to reflect the current operation of the fuel injectors. Operation 614 includes repeating the method 600 at different operating points to adjust the calibration table or the parameter.

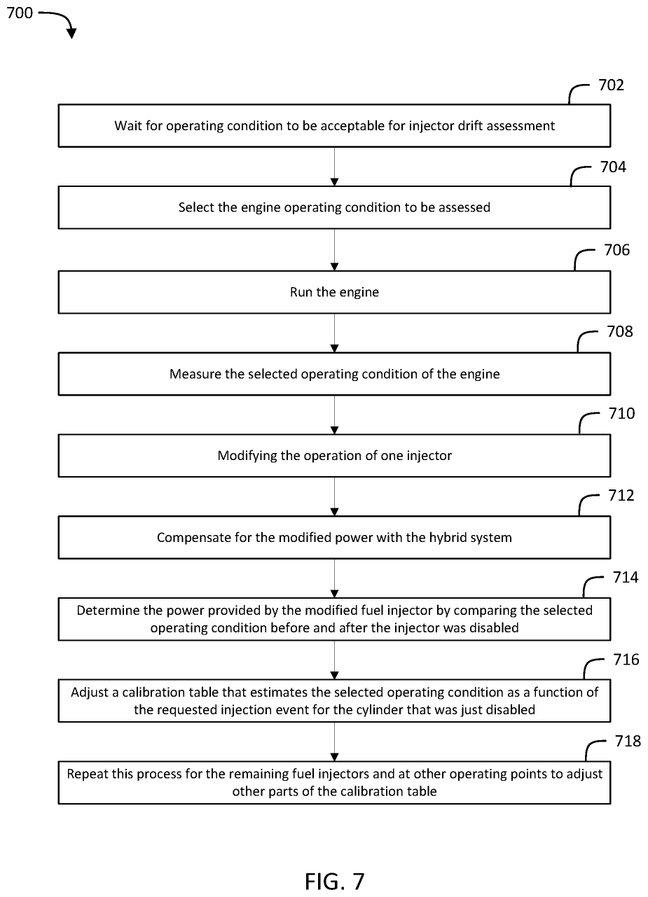

FIG. 7 shows a flow diagram of a method 700 for calibrating fuel injection within an engine system is shown according to exemplary embodiment. The method 700 can be implemented on any of the engine systems described herein, such the mono-fuel engine system 202. The method 700 includes monitoring for an operating condition of the engine system to be acceptable for injector drift assessment; selecting an engine operating condition to be assessed; running the engine; measuring actual engine power; modifying the operation of one injector; compensating for the modified power with the hybrid system; determining the power provided by the disabled fuel injector by comparing the selected operating condition before and after the injector was disabled; adjusting a calibration table or correlation that estimates the selected operating condition as a function of the requested injection event for the cylinder that was just disabled; and repeating the process for the remaining fuel injectors and at other operating points to adjust the calibration table.

Upon determining that assessment of injector drift is to be performed, the method 700 begins at operation 702. Operation 702 includes monitoring whether the operating condition is acceptable for injector drift assessment. These operating conditions are described in more detail above.

Operation 704 includes selecting the engine operating condition to be assessed. For example, in some embodiments, the power output of the engine can be selected as the operating condition to be assessed. As another example, the speed of the engine can be selected as the operating condition to be assessed.

Operation 706 includes running the engine. In some embodiments, the engine can be run at a steady state. In some embodiments, the engine can be run using only a first or primary fuel at operation 706. The engine can be commanded to produce an amount of power to meet a requested power demand. In some embodiments, where the engine is unable to meet the requested power demand, the hybrid system can provide difference between the requested power demand the engine power output.

Operation 708 includes measuring the selected operating condition of the engine which was selected at operation 704. For example, if the selected operating condition is engine power, the actual engine power output is measured at operation 708. As another example, if the selected operating condition is engine speed, the actual engine speed is measured at operation 708.

Operation 710 includes modifying the operation of one fuel injector. In some embodiments, modifying the operation of the fuel injector can include decreasing (or increasing) the amount of fuel provided by the fuel injector. In some embodiments, modifying the operation of the fuel injector can include disabling the fuel injector such that the fuel injector does not provide any fuel. Modifying operation of the fuel injector can cause the power output of the engine to reduce below a requested power demand. In such a case, the loss in power output for the engine can be compensated for by a hybrid system at operation 712.

Operation 714 includes determining the power output provided by the modified fuel injector by comparing the measured operating condition before and after the fuel injector was modified. In some embodiments, comparing the measured operating condition before and after the fuel injector is reduced or disabled can indicate the amount fuel being injected by the one or more fuel injectors. Based on this comparison, a magnitude of a difference between the expected output of the engine and the actual output of the engine can be used to characterize the performance of the fuel injector and/or calibrate the fuel injector.

Operation 716 includes adjusting a calibration table or the parameter that estimates the selected operating condition as a function of the requested injection event. Specifically, the table or correlation can be referred herein as the calibration parameter. The calibration parameter can be adjusted based on the power provided by the fuel injector determined at operation 714. For example, if the power provided by the fuel injector is similar to what is expected according to a calibration table or parameter based on the power demand requested by the engine, the calibration table or parameter cannot be updated. In contrast, if the power provided by the fuel injector is not similar (e.g., different by more than a certain threshold) to what is expected according to a calibration table or parameter based on the power demand requested by the engine, the calibration parameter can be updated to reflect the current operation of the fuel injectors. Operation 718 includes repeating the method 700 for the remaining fuel injectors and at different operating points to adjust the calibration table or the parameter.

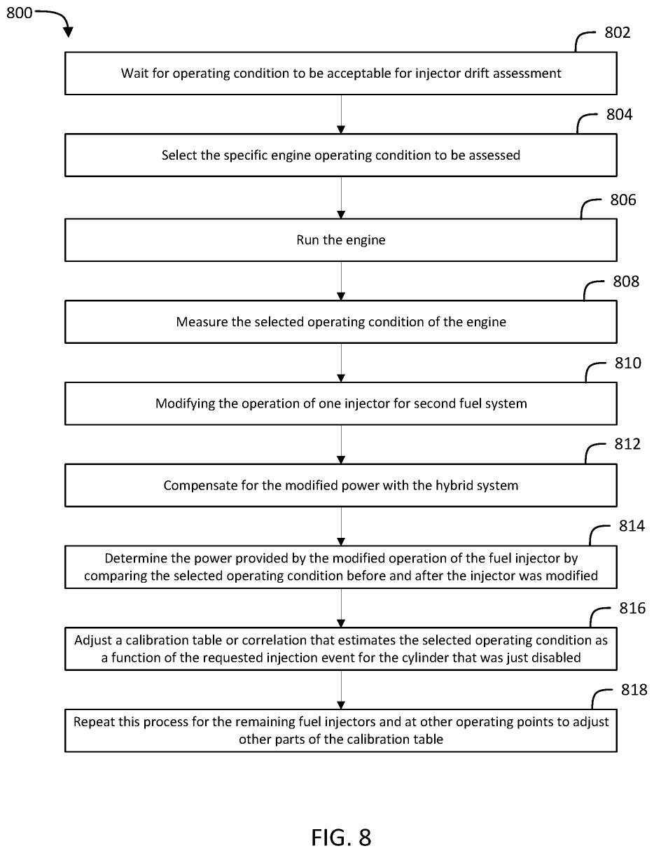

FIG. 8 shows a flow diagram of a method 800 for calibrating fuel injection within an engine system is shown according to exemplary embodiment. The method 800 can be implemented on any of the engine systems described herein, such the dual-fuel engine system 302. The method 800 includes monitoring whether an operating condition is acceptable for injector drift assessment; selecting the specific engine operating condition to be assessed; running the engine; measuring actual engine power; modifying the operation of one injector for second fuel system; compensating for reduced or increased power with the hybrid system; determining the power provided by the modified operation of the fuel injector by comparing the selected operating condition before and after the injector was modified; adjusting a calibration table or correlation to estimate the selected operating condition as a function of the requested injection event for the cylinder that was disabled; and repeating this process for the remaining fuel injectors and at other operating points to adjust the calibration table.

In some embodiments, the method 800 includes operating, based on a target load for the engine, an injector coupled with the engine according to a parameter for the injector corresponding to the target load; operating the engine in a dual fuel mode in which a primary fuel is supplied to the engine by a first fuel injector and a secondary fuel is supplied to the engine by a second fuel injector; modifying the operation of the second fuel injector of the engine; comparing an actual engine power output of the engine determined before modifying the operation of the second fuel injector and an actual power output of the engine determined after modifying the operation of the second fuel injector; and updating the parameter based on the comparison. In some embodiments, the method 800 includes providing, by the electric motor, a first power output to compensate for a reduced engine power output subsequent to disabling of the second fuel injector. In some embodiments, one or more operations of the method 800 can be performed by at least one of a motor or a generator (e.g., a motor-generator), to facilitate adding or absorbing power in relation to the modification of operation of the fuel injector(s). This can include, for example, using the generator to compensate for a modified (e.g., increased or decreased) engine power output.

Responsive to determining to assess injector drift, the method 800 begins at operation 802. Operation 802 includes monitoring for an operating condition to be acceptable for injector drift assessment. These operating conditions are described in more detail above.

Operation 804 includes selecting the engine operating condition to be assessed. For example, in some embodiments, the power output of the engine can be selected as the operating condition to be assessed. As another example, the speed of the engine can be selected as the operating condition to be assessed.

Operation 806 includes running the engine. In some embodiments, the engine can be run at a steady state. In some embodiments, the engine can be run using only a first or primary fuel at operation 806. The engine can be commanded to produce a certain amount of power to meet a requested power demand. However, in some cases, the engine cannot be able to meet the requested power demand. In such cases, the hybrid system can provide difference between the requested power demand the engine power output.

Operation 808 includes measuring the selected operating condition of the engine which was selected at operation 804. For example, if the selected operating condition is engine power, the actual engine power output is measured at operation 808. As another example, if the selected operating condition is engine speed, the actual engine speed is measured at operation 808.

Operation 810 includes modifying the operation of one fuel injector for second fuel system. In some embodiments, modifying the operation of the fuel injector of the second fuel system can include decreasing the amount of fuel provided by the fuel injector. In some embodiments, modifying the operation of the fuel injector can include disabling the fuel injector such that the fuel injector does not provide fuel. Modifying operation of the fuel injector can cause the power output of the engine to reduce below a requested power demand. In such a case, the loss in power output for the engine can be compensated for by a hybrid system at operation 812.

Operation 814 includes determining the power output provided by the modified fuel injector by comparing the measured operating condition before and after the fuel injector was modified. In some embodiments, comparing the measured operating condition before and after the fuel injector is reduced or disabled can indicate the amount fuel being injected by the one or more fuel injectors. Based on this comparison, a magnitude of a difference between the expected output of the engine and the actual output of the engine can be used to characterize the performance of the fuel injector and/or calibrate the fuel injector.

Operation 816 includes adjusting a calibration table or parameter that estimates the selected operating condition as a function of the requested injection event. Specifically, the table or correlation can be referred herein as the calibration parameter. The calibration parameter can be adjusted based on the power provided by the fuel injector determined at operation 814. For example, if the power provided by the fuel injector is similar to what is expected according to a calibration table or parameter based on the power demand requested by the engine, the calibration table or parameter cannot be updated. In contrast, if the power provided by the fuel injector is not similar (e.g., more than a certain threshold difference) to what is expected according to a calibration table or parameter based on the power demand requested by the engine, the calibration parameter can be updated to reflect the current operation of the fuel injectors. Operation 818 includes repeating the method 800 for the remaining fuel injectors and at different operating points to adjust the calibration table or the parameter.

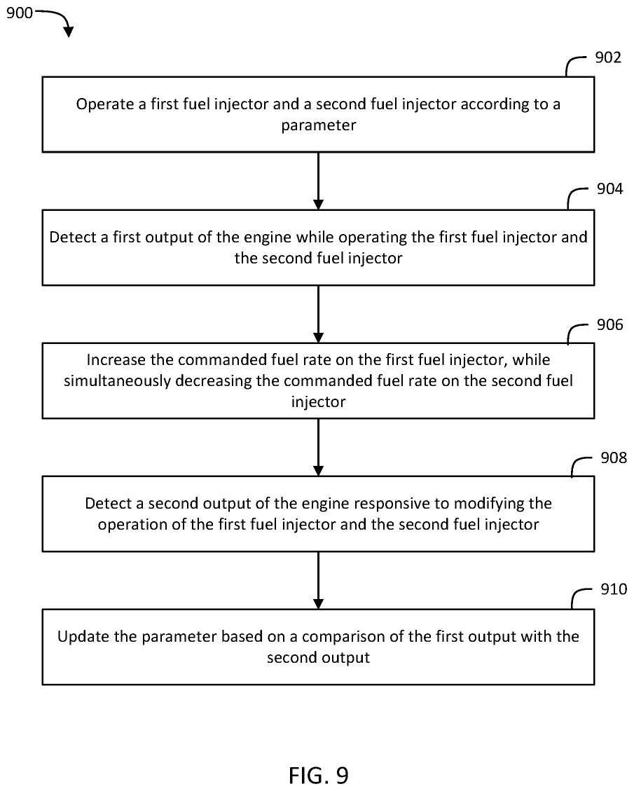

FIG. 9 shows a flow diagram of a method 900 for calibrating fuel injection within an engine system is shown according to exemplary embodiment. The method 900 can be implemented on any of the engine systems described herein, such the mono-fuel engine system 202 and the dual fuel engine system 302 described with reference to FIGS. 2-3. The method 900 includes: operating, based on a target load for the engine, a first fuel injector and a second fuel injector coupled with the engine according to a first parameter for the first fuel injector and a second parameter for the second fuel injector, wherein the first parameter corresponds to a first fuel rate for the first fuel injector corresponding to the target load, and the second parameter corresponds to a second fuel rate for the second fuel injector corresponding to the target load; detecting a first output of the engine while operating the first fuel injector and the second fuel injector according to the parameters; modifying operation of the first fuel injector and the second fuel injector; comparing an actual engine power output of the engine determined before modifying the operation of the first fuel injector and the second fuel injector and an actual power output of the engine determined after modifying the operation of the first fuel injector and the second fuel injector; and updating the parameter based on a comparison. The method 900 can be used to facilitate calibration of multiple injectors and/or detecting which of multiple injectors is to have calibration operations performed. In some embodiments, modifying the operation of the first fuel injector and the second fuel injector comprises increasing the first fuel rate on the first fuel injector, while simultaneously decreasing the second fuel rate on the second fuel injector.

Operation 902 includes operating, based on a target load for an engine, a first fuel injector according to a first parameter corresponding to the target load and a second fuel injector according to a second parameter corresponding to the target load. Operation 902 can include actuating or causing the first fuel injector and/or the second fuel injector to release a certain amount of fuel into the combustion chamber of an engine based on a target load for an engine. In some embodiments, the amount of fuel injected can be determined according to a calibration parameter or table for the fuel injector corresponding to the target load. The calibration parameter or table maps the power output of the engine as a function of a commanded injection amount. The first parameter can correspond to a first fuel rate for the first fuel injector corresponding to the target load, and the second parameter can correspond to a second fuel rate for the second fuel injector corresponding to the target load.

Operation 904 includes detecting a first output of the engine while operating the first fuel injector according to the first parameter and the second fuel injector according to the second parameter. Specifically, operation 904 can include determining a first power output of the engine while operating the first fuel injector the second fuel injector, according to the parameter as described above at operation 902.

Operation 906 includes modifying operation of the first fuel injector and the second fuel injector. In some embodiments, modifying the operation of the fuel injector(s) can include increasing the commanded fuel rate on the first fuel injector, while simultaneously decreasing the commanded fuel rate on the second fuel injector. In some embodiments, the increased commanded fuel rate in the first injector is equal to the decreased commanded fuel rate in the second injector. For example, when the commanded fuel rate for the first injector is increased by a first amount, the commanded fuel rate for the second injector is decreased by that same first amount. In some embodiments, the increased commanded fuel rate in the first injector is not equal to the decreased commanded fuel rate in the second injector.

Operation 908 includes detecting a second output of the engine responsive to modifying the operation of the first fuel injector and the second fuel injector. For example, operation 908 can include determining a second power output of the engine while operating the fuel injectors in a modified condition. For example, when both the first fuel injector and the second fuel injector are functioning as intended, then the second power output of the engine is expected to be substantially constant. The controller 400 can determine the accuracy associated with fueling of individual injectors by determining the change in power when the total combined commanded fuel rate is constant or the change in total commanded fuel rate when the power is constant. Thus, the controller 400 can be configured to determine whether an individual injector is under-performing (e.g., defective). In particular, when increasing the fuel rate of the first fuel injector by a specified amount and decreasing the fuel rate of the second fuel injector by that amount results in a change in power that exceeds a threshold, the controller 400 can determine that the first and/or the second injector is under-performing. The controller 400 can determine a performance of an individual injector based on the threshold. In some embodiments, the controller 400 can categorize an individual injector as under-performing or normally performing based on the threshold, for example. Further, the controller 400 can be configured to compare the first injector and the second injector to any other injectors coupled to the engine to characterize the other injectors.

Operation 910 includes comparing the first output with the second output. For example, the comparison can indicate whether there are differences between how the fuel injectors are commanded relative to the resulting power of the engine.

Operation 912 includes updating the first parameter based on the comparison to determine an updated first parameter and the second parameter based on the comparison to determine an updated second parameter. For example, responsive to determining that the first output is different than the second output, at least one of the first parameter can be modified or the second parameter can be modified. In some embodiments, responsive to determining that the first output is different than the second output, the first fuel injector or the second fuel injector can have its operation modified while maintaining the operation of the other of the first fuel injector or the second fuel injector, such as to determine which of the first fuel injector or the second fuel injector (or both) contributes to the difference between the first output and the second output.

In some embodiments, the controller can send a notification or message to an operator that a specific injector is due for servicing. In some embodiments, the controller can determine a “percent of life left” (e.g., a remaining useful life) for the fuel injectors based on the comparison of the second power to the threshold. The controller can determine an amount by which to adjust the parameter corresponding to the commanded fuel rate based on the commanded fuel rate (e.g., to make varied adjustments depending on the commanded fuel rate, such as to calibrate the fuel injector operation dynamically with respect to the commanded fuel rate. This can allow, for example, injectors that are expected to meet a performance criterion at a first commanded fuel rate to be run at a second fuel rate so that the controller can assess performance at the second commanded fuel rate. In some embodiments, if the controller has not yet determined injector performance at a given commanded fuel rate, the controller can determine a correction for the injector based on an average correction value (e.g., for other fuel rates for which calibration has been performed). In some embodiments, responsive to determining that the fuel injectors are under-performing, the controller can terminate a dual fuel operation mode in the engine system.

Operation 914 includes operating the first fuel injector according to the updated first parameter and the second fuel injector according to the updated second parameter. For example, at least one of the first fuel injector or the second fuel injector can be provided control signals indicating an updated commanded fuel rate that may differ from the initial commanded fuel rate, while accounting for the difference between the first output and the second output. This can facilitate calibration of the fuel injectors, e.g., by allowing the controller that commands the fuel injectors to transmit command signals based on the respective updated first and second parameters. For example, the controller can transmit command signals using the updated first and second parameters so that the resulting operation of the first and second fuel injectors corresponds to the target load for the engine. The resulting operation can result in a lesser difference between first and second outputs, for example.

It should be noted that the term “example” as used herein to describe various embodiments is intended to indicate that such embodiments are possible examples, representations, and/or illustrations of possible embodiments (and such term is not intended to connote that such embodiments are necessarily extraordinary or superlative examples).

As utilized herein, the term “substantially” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

The terms “coupled,” “connected,” and the like as used herein mean the joining of two members directly or indirectly to one another. Such joining can be stationary (e.g., permanent) or moveable (e.g., removable or releasable). Such joining can be achieved with the two members or the two members and any additional intermediate members being integrally formed as a single unitary body with one another or with the two members or the two members and any additional intermediate members being attached to one another.

It is important to note that the construction and arrangement of the various exemplary embodiments are illustrative only. Although certain embodiments have been described in detail in this disclosure, those skilled in the art who review this disclosure will readily appreciate that various modifications are possible without materially departing from the novel teachings and advantages of the subject matter described herein. Other substitutions, modifications, changes and omissions can also be made in the design and arrangement of the various exemplary embodiments without departing from the scope of the embodiments described herein.

While this specification contains specific implementation details, these should not be construed as limitations on the scope of any embodiment or of what can be claimed, but rather as descriptions of features specific to particular implementations of particular embodiments. Certain features described in this specification in the context of separate implementations can also be implemented in combination in a single implementation. Conversely, various features described in the context of a single implementation can also be implemented in multiple implementations separately or in any suitable subcombination. Moreover, although features can be described above as acting in certain combinations and even initially claimed as such, one or more features from a claimed combination can in some cases be excised from the combination, and the claimed combination can be directed to a subcombination or variation of a subcombination.

What is claimed is:

1. A method of fuel injector calibration for use with a fuel injector coupled with an engine, the method comprising:
operating the fuel injector according to a parameter for the fuel injector that corresponds to a first target load for the engine;
detecting a first output of the engine while operating the fuel injector according to the parameter;
modifying the operation of the fuel injector;
detecting a second output of the engine responsive to modifying the operation of the fuel injector; and
updating the parameter based on a comparison of the first output with the second output.

2. The method of claim 1, further comprising:
operating the engine in a primary fuel only mode in which only a primary fuel is supplied to the engine.

3. The method of claim 1, further comprising:
operating the fuel injector based on the updated parameter.

4. The method of claim 1, wherein modifying the operation of the fuel injector comprises disabling the fuel injector or operating the fuel injector at a partial level relative to a maximum operating capacity of the fuel injector.

5. The method of claim 1, further comprising:
providing a first power output to compensate for a reduced engine power output during the modified operation of the fuel injector.

6. The method of claim 1, further comprising:
operating, based on a second target load for the engine, the fuel injector coupled with the engine according to a parameter for the fuel injector corresponding to the second target load;
modifying the operation of the fuel injector; and
providing a second power output to compensate for a reduced engine power output during the modified operation of the fuel injector.

7. The method of claim 6, further comprising:
detecting a third output of the engine responsive to modifying the operation of the fuel injector; and
updating the parameter based on a comparison of the second output with the third output.

8. The method of claim 1, wherein updating the parameter comprises updating at least one of a function associated with the parameter or a lookup table associated with the parameter.

9. A calibration system for one or more fuel injectors coupled to an engine, the calibration system comprising:
a hybrid system including an electric motor and a battery each providing power; and
a controller configured to:
operate a first fuel injector of the one or more fuel injectors according to a parameter corresponding to a first target load for the engine;
modify operation of the first fuel injector;
control the electric motor to provide a power output based on the first target load and a modified engine power output caused by modifying the operation of the first fuel injector;
determine a first power output associated with a fuel provided by the first fuel injector based on a difference between an actual engine power output determined before modifying the operation of the first fuel injector and an actual engine power output determined after modifying the operation of the first fuel injector; and
operate the engine based on a second target load different than the first target load by:
reducing fueling of the first fuel injector to a target fueling level associated with the first target load; and
controlling the electric motor to provide a power output based on the second target load and a reduced power output caused by reducing fueling of the first fuel injector.

10. The calibration system of claim 9, wherein the controller is configured to operate the first fuel injector according to the parameter by transmitting a command to the first fuel injector to cause the first fuel injector to output the fuel at a fuel rate corresponding to the parameter.

11. The calibration system of claim 9, wherein the engine is configured to be fueled by a primary fuel and a secondary fuel.

12. The calibration system of claim 9, wherein the controller is further configured to:
determine a variation between a maximum primary fuel injector power output value and a minimum primary fuel injector power output value; and at least one of:
in response to the variation being greater than a first error margin, provide a signal indicating a fault;
in response to the variation being greater than a second error margin, provide a signal to disable dual fuel operation of the engine; or
in response to the variation being more than a third error margin, provide a signal to disable dual fuel operation of the engine and to de-rate engine power.

13. The calibration system of claim 9, wherein the controller is further configured to:
determine a second primary fuel injector power output based on a difference between an actual engine power output determined before reducing fueling of the first fuel injector and an actual engine power output determined after reducing fueling of the first fuel injector; and
update the parameter based on the second primary fuel injector power output.

14. The calibration system of claim 13, wherein the controller is further configured to:
determine a target power output;
operate the engine to provide a set engine power output different from the target power output;
control the electric motor to provide a power output based on the set engine power output and the target power output; and
determine a total fuel injector power output by comparing an actual engine power output and the set engine power output.

15. The calibration system of claim 14, wherein the controller is further configured to:
determine a first difference between the total fuel injector power output and the first fuel injector power output;
determine a second difference between the total fuel injector power output and the second primary fuel injector power output; and
in response to at least one of the first difference or the second difference being greater than a first error margin, provide a signal indicating a fault.

16. The calibration system of claim 15, wherein the controller is further configured to:
in response to at least one of the first difference or the second difference being greater than a second error margin, provide a signal to disable dual fuel operation of the engine.

17. The calibration system of claim 15, wherein the controller is further configured to:
in response to at least one of the first difference and the second difference being greater than a second error margin, provide a signal to de-rate engine power.

18. The calibration system of claim 10, wherein the controller is further configured to:
in response to the hybrid system operating in a dual fueling mode:
operate the engine based on a third target load;
disable a secondary fuel injector of the engine; and
control the electric motor to provide a power output based on the third target load and a reduced engine power output caused by disabling the secondary fuel injector.

19. A method of calibrating fuel injection for a system including an engine, the method comprising:
operating, based on a target load for the engine, a first fuel injector and a second fuel injector coupled with the engine according to a first parameter for the first fuel injector and a second parameter for the second fuel injector, wherein the first parameter corresponds to a first fuel rate for the first fuel injector corresponding to the target load, and the second parameter corresponds to a second fuel rate for the second fuel injector corresponding to the target load;
detecting a first output of the engine while operating the first fuel injector according to the first parameter and the second fuel injector according to the second parameter;
modifying operation of the first fuel injector and the second fuel injector;
detecting a second output of the engine responsive to modifying the operation of the first fuel injector and the second fuel injector;
comparing the first output with the second output;
updating the first parameter based on the comparison to determine an updated first parameter and the second parameter based on the comparison to determine an updated second parameter; and
operating the first fuel injector according to the updated first parameter and the second fuel injector according to the updated second parameter.

20. The method of claim 19, wherein modifying the operation of the first fuel injector and the second fuel injector comprises increasing the first fuel rate on the first fuel injector, while simultaneously decreasing the second fuel rate on the second fuel injector.
